(19) United States
(12) Patent Application Publication
(10) Pub. No.: US 2026/0292150 A1
(43) Pub. Date: Sep. 24, 2026

(54) METHODS AND APPARATUS OF DECODER-SIDE INTRA MODE DERIVATION AND PREDICTION WITH INHERITED HISTOGRAM OF GRADIENTS FROM THE NEIGHBOURHOOD IN VIDEO CODING

(71) Applicant: MEDIATEK INC., Hsinchu City (TW)

(72) Inventors: Hong-Hui CHEN, Hsinchu City (TW); Man-Shu CHIANG, Hsinchu City (TW); Hsin-Yi TSENG, Hsinchu City (TW); Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW)

(21) Appl. No.: 19/473,121

(22) PCT Filed: Nov. 15, 2024
(86) PCT No.: PCT/CN2024/132182

§ 371 Date: Oct. 6, 2025

Related U.S. Application Data
(60) Provisional application No. 63/601,867, filed on Nov. 22, 2023.

(51) Int. Cl. H04N 19/11; H04N 19/136; H04N 19/176; H04N 19/593

(52) U.S. Cl. CPC H04N 19/11; H04N 19/136; H04N 19/176; H04N 19/593

(57) ABSTRACT

A method and apparatus for video coding by storing HoG of the current block for use by one or more subsequent blocks are disclosed. According to the method, input data associated with a current block is received, wherein the input data comprise pixel data to be encoded at an encoder side or data associated with the current block to be decoded at a decoder side, wherein the current block is coded in a non-DIMD (Decoder-Side Intra Mode Derivation) mode. A HoG (Histogram of Gradients) derived for a non-DIMD process associated with the current block is determined. The HoG is stored in a buffer. A subsequent block of the current block is encoded or decoded by using information comprising the HoG.

### CROSS REFERENCE TO RELATED APPLICATIONS

The present invention is a non-Provisional Application of and claims priority to U.S. Provisional Patent Application No. 63/601,867, filed on Nov. 22, 2023. The U.S. Provisional Patent Application is hereby incorporated by reference in its entirety.

### FIELD OF THE INVENTION

The present invention relates to video coding system. In particular, the present invention relates to derivation, storage and reuse of HoG (Histogram of Gradients) for non-DIMD (Decoder-Side Intra Mode Derivation) coded blocks in a video coding system.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed and stored at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it is a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derivation based on multi-type tree syntax elements

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf qdtree node can be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### Intra Prediction

Prediction of the CU is performed based on the pixels contained in PU (prediction unit). Prediction can be formed by neighbouring pixels or pixels in the reference frames. These pixels are available both for encoder and decoder, therefore the coding flow is valid for the codec where same prediction can be generated between the encoder and decoder. The prediction involves neighbouring pixels only is intra prediction. There are several kinds of intra prediction used in VVC, including DC, planar, angular, etc. The common step is to get the pixels from the neighbouring pixels. These neighbouring pixels may contribute from multiple CUs. For example, in FIG. 5, the neighbouring L-shape for the angular prediction is shown. Pixels from multiple neighbouring CUs are utilized in the prediction process.

### Inter Prediction

Forming the prediction by referring the pixels in reference frames is the basic procedure conducted in the inter prediction. FIG. 6 is an example of bi-directional inter prediction. There are two motion vectors, MVL0 and MVL1 used to fetch the pixels.

The fetched area of the reference frame may also have multiple CUs involved. As shown in FIG. 7, the fetched area is denoted by the dark dashed area and there are nine CUs involved in this area.

### Combined Inter and Intra Prediction (CIIP)

This is another type of prediction that combines inter prediction and intra prediction together. By blending the pixels from the two predictions, the final prediction is got. As mentioned in section entitled Intra Prediction and Inter Prediction, the predictions before blending can be formed from multiple CUs.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as dotted arrows in FIG. 8, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks. Decoder Side Intra Mode Derivation (DIMD)

When DIMD is applied, five intra modes are derived from the reconstructed neighbour samples, and those five predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, cantered on the pixels of the middle line of the template. At each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) , \qquad ( 1 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 2 )$$

FIGS. 9A-C show an example of HoG, calculated after applying the above operations on all pixel positions in the template. FIG. 9A illustrates an example of selected template 220 for a current block 910. Template 920 comprises T lines above the current block and T columns to the left of the current block. For intra prediction of the current block, the area 930 at the above and left of the current block corresponds to a reconstructed area and the area 940 below and at the right of the block corresponds to an unavailable area. FIG. 9B illustrates an example for T=3 and the HoGs are calculated for pixels 960 in the middle line and pixels 962 in the middle column. For example, for pixel 952, a 3×3 window 950 is used. FIG. 9C illustrates an example of the amplitudes (ampl) calculated based on equation (2) for the angular intra prediction modes as determined from equation (1).

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (~1/3). The remaining weight of 43/64 (~2/3) is then shared between the two HoG IPMs, proportionally to the amplitude of their HoG bars. FIG. 10 illustrates this fusion process.

Besides, the two implicitly derived intra modes are included in the MPM (Most Probable Modes) list, so the DIMD process is performed before the MPM list is constructed. The primary derived intra mode of a DIMD block is stored with the block and is used for MPM list construction of the neighbouring blocks.

### IntraTMP (Intra Template Matching Prediction) and IBC (Intra Block Copy)

FIGS. 11A-B show the concept of intraTMP, the L-shape template is used to search the area R1 to R6 to get a displacement vector (i.e., BV (block vector)) which is similar to MV. IntraTMP is a intra coding mode and it can only search the available reconstructed area reconstructed so far. This area is both available for the encoder and the decoder while process the current CU. As for IBC, it coding procedure is similar to intraTMP except that IBC uses original pixel of current CU to search it search region to get BV.

### Template Matching Cost for Mode Derivation

For mode selection, template matching method can be applied by computing the cost between reconstructed samples and predicted samples. One of the examples is Template-Based Intra Mode Derivation (TIMD). TIMD implicitly derives the intra prediction mode of a CU by using a neighbouring template at both encoder and decoder, instead of being signal exact intra prediction mode bits to the decoder. As shown in FIG. 12, the prediction samples of the template are generated using the reference samples of the template for each candidate mode. A cost is calculated as the SATD between the prediction and the reconstruction samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 \times costMode 1.$$

If this condition is true, the fusion is applied, otherwise the only model is used. Weights of the modes are computed from their SATD costs as follows:

$$weight 1 = costMode 2 / ( costMode 1 + costMode 2 )$$

$$weight 2 = 1 - weight 1$$

### Boundary Matching Cost for Mode Derivation

In JVET-X0146, a method called boundary matching (BM) is proposed as a cost function to evaluate the discontinuity across block boundary. The involved neighbourhood of the BM is shown in FIG. 13.

The formula to calculate BM cost is list as follows:

$$cost = {\sum }_{x = o}^{w} ( \vert 2 {P}_{x , 1} - {P}_{x , 2} - {R}_{x , 0} \vert + \vert 2 {R}_{x , 0} - {P}_{x , 1} - {R}_{x , - 1} \vert ) + {\sum }_{y = o}^{h} ( \vert 2 {P}_{1 , y} - {P}_{2 , y} - {R}_{0 , y} \vert + \vert 2 {R}_{0 , y} - {P}_{1 , y} - {R}_{- 1 , y} \vert ) .$$

In the present invention, we propose to derive, store and reuse the HoG of non-DIMD coded blocks to improve the coding performance of DIMD prediction.

### BRIEF SUMMARY OF THE INVENTION

A method and apparatus for video coding by storing HoG of the current block for use by one or more subsequent blocks are disclosed. According to the method, input data associated with a current block is received, wherein the input data comprise pixel data to be encoded at an encoder side or data associated with the current block to be decoded at a decoder side, wherein the current block is coded in a non-DIMD (Decoder-Side Intra Mode Derivation) mode. A HoG (Histogram of Gradients) derived for a non-DIMD process associated with the current block is determined. The HoG is stored in a buffer. A subsequent block of the current block is encoded or decoded by using information comprising the HoG.

In one embodiment, the HoG is generated for one or more non-angular coded intra modes. In one embodiment, said one or more non-angular coded intra modes comprise MIP (Matrix-based Intra Prediction), intraTMP (Intra Template Matching Prediction), SGPM (Spatial Geometric Partitioning Mode) with MTS (Multiple Transform Selection) and LFNST (Low-Frequency Non-separable Secondary Transform) selected by DIMD. In one embodiment, the HoG is generated during intra MPM (Most Probable Modes) derivation for TIMD (Template-Based Intra Mode Derivation), IBC (Intra Block Copy)-GPM (Geometric Partitioning Mode), CIIP (Combined Inter and Intra Prediction), or IBC-CIIP.

In one embodiment, the HoG corresponds to a representative HoG generated for the current block coded in an inter mode. In one embodiment, the representative HoG is generated based on a predefined area of the current block. In one embodiment, the predefined area of the current block corresponds to an L-shape template outside and adjacent to the current block, part or all of the current block, or a combination thereof.

In one embodiment, the representative HoG is stored only if one or more conditions are satisfied. In one embodiment, said one or more conditions comprise checking statistics of the representative HOG. In one embodiment, the statistics of the representative HOG comprise standard deviation of histogram entry values. In one embodiment, said one or more conditions comprise checking nearby blocks coded with an intra mode. In another embodiment, said one or more conditions comprise checking amount of coding residues. In yet another embodiment, said one or more conditions comprise checking non-adjacent blocks coded with an intra mode.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 illustrates an example of pixels in an L-shape neighbouring region involving multiple neighbouring CUs.

FIG. 6 illustrates an example of bi-directional inter prediction.

FIG. 7 illustrates an example of pixel fetching area by motion vector and the involved CUs in the reference frame.

FIG. 8 illustrates the 67 intra prediction modes adopted in VVC.

FIG. 9A illustrates an example of selected template for a current block, where the template comprises T lines above the current block and T columns to the left of the current block.

FIG. 9B illustrates an example for T=3 and the HoGs (Histogram of Gradient) are calculated for pixels in the middle line and pixels in the middle column.

FIG. 9C illustrates an example of the amplitudes (ampl) for the angular intra prediction modes.

FIG. 10 illustrates an example of the blending process, where two intra modes (M1 and M2) and the planar mode are selected according to the indices with two tallest bars of histogram bars.

FIG. 11A illustrates the concept of intraTMP where the L-shape template is used to search the areas R1 to R6 to get a displacement vector (i.e., block vector).

FIG. 11B illustrates an example of the derivation of intraTMP for a current block based on the displacement vector (i.e., block vector).

FIG. 12 illustrates an example of template-based intra mode derivation (TIMD) mode, where TIMD implicitly derives the intra prediction mode of a CU using a neighbouring template at both the encoder and decoder.

FIG. 13 illustrates shows the involved neighbouring pixels for boundary matching.

FIG. 14 illustrates an example of neighbouring regions and related neighbouring CUs for building the HoG for the current block according to one embodiment of the present invention.

FIGS. 15A-C illustrate examples of position-dependent weights for predictor blending.

FIG. 16 illustrates an example of neighbouring and non-adjacent locations to search the inter CUs for HoG generation.

FIG. 17 illustrates a flowchart of an exemplary video coding system that stores and reuses the HoG of non-DIMD coded blocks according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The following methods are proposed to improve the Decoder-side Intra Mode Derivation (DIMD) prediction accuracy and coding performance.

The original DIMD method adopts the adjacent L shape with thickness of 3 samples to build the histogram of gradients (HoG). In this invention, we further consider the already built HoGs from the neighbouring CUs for building the HoG for the current CU for deriving the intra modes. The neighbouring CUs can be from above region (A), left region (L), above-right region (AR), above-left region (AL) and bottom-left region (BL) as shown in FIG. 14. In FIG. 14, the neighbouring CUs are CU_T0, CU_T1, CU_T2, CU_TLC, CU_L0, CU_L1, CU_BLC, CU_B0, CU_B1, CU_B2, CU_BRC, CU_R0, and CU_TR.

In the above region there are three CUs (i.e., CU_T0, CU_T1, CU_T2) adjacent to the current CU. The left region has two adjacent CUs. Regions AL and BL only have one CU adjacent to the current CU. These adjacent CUs can be encoded as intra CUs or inter CUs. In the following, several methods are disclosed to encode the current CU with extend methods based on DIMD.

### 1. HoG Storing in Buffer

For an I slice, all the neighbouring CUs are intra CUs. Some of them can be encoded with DIMD flag set true. For DIMD derivation process, a histogram of the gradients (HoG) is built to derive the intra modes for prediction blending. For the current DIMD method in Enhanced Compression Model (ECM) version 9 (Muhammed Coban, et al., “Algorithm description of Enhanced Compression Model 9 (ECM 9)”, Joint Video Exploration Team (JVET) of ITU-T SG 16 WP 3 and ISO/IEC JTC 1/SC 29/WG 11, 30th Meeting, Antalya, TR, 21-28 Apr. 2023, Document: JVET-AD2025), HoG is not stored for use by future CUs. In this method, an extra buffer for storing the HoG is allocated. HoG is stored according to following conditions:
C.1 A CU is coded with DIMD mode
C.2 A CU is not coded with DIMD mode, but encoded with angular intra mode with the angular intra mode having the highest HoG's amplitude
C.3 A CU is not coded with DIMD mode, but encoded with angular intra mode with the angular intra mode having the HoG's amplitude among the first K highest amplitudes
C.4 A CU is coded with angular intra mode
C.5 Always store the HoG of a CU

Conditions C1 to C3 can be applied individually. Otherwise, they can be applied jointly. For example, C.1 and C.2 can be used together as the condition for storing the HoG. Condition C.2 is a limited version of C.3 by setting the K to 1. For C.1, DIMD flag in picture-level coding structure can be used for deciding the availability of the stored HoG. For C.2 or C.3, an extra flag is required for checking the available of the HoG.

For the current DIMD algorithm, the HoG is composed of 67 bins for all possible angular intra modes. In one embodiment, all the bins of HoG are stored. However, to store all the bins of HoG imposes a high buffer storage requirement. Therefore, in another embodiment, only M bins with the highest amplitudes are stored. For example, M can be 10. Otherwise, bins of HoG can be combined first before storing. For example, intra modes from 2 to 5 can be summed and shifted right by S bits, where S can be zero for no shift. For this example, S can be 2 for restoring the value range after summing the bins together. The stored HoGs are used in the coding methods proposed in the following sections.

### 2. Pure DIMD Inheritance Mode

With the availability of neighbouring HoGs when encoding the current CU, the neighbouring HoGs can be used to build an inherited HoG for the current CU. There is no need to calculate the gradients of the L shape of the current CU and only use the bins from the stored neighbouring HoGs to compose a HoG for the current CU. The HoG for the current CU can be constructed by averaging the neighbouring HoGs for some embodiments. For other embodiments, weighted averaging of the HoGs can be used. The weight of a certain HoG is proportional to a confidence factor of the neighbouring CU. The higher the confidence factor is, the higher weight is assigned. The following formula shows the weighted averaging for HoGs from the above and left sides (assuming only above and left side CUs with valid HoGs) of FIG. 14:

$$BinCurrentCU [ K ] = \{ CF 0 * BinCU\_A0 [ K ] + CF 1 * BinCU\_A1 [ K ] + CF 2 * BinCU\_A2 [ K ] + CF 3 * BinCU\_L0 [ K ] + CF 4 * BinCU\_L1 [ K ] \} / \{ CF 0 + CF 01 + CF 02 + CF 03 + CF 04 \} ,$$

where CF represents confidence factor and K represents a bin index.

For one embodiment, the confidence factor can be related to whether the neighbouring CU is intra coded or not. In one embodiment, if the CU used to build the neighbouring HoG is intra coded, multiplying a factor greater than one and/or adding an offset greater than zero to the weight can be utilized. In another embodiment, if the CU used to build the neighbouring HoG is inter coded, multiplying a factor smaller than one and/or adding an offset less than zero to the weight can be utilized. In another embodiment, intra coded neighbouring CU with confidence factor set to 3 for its bins of HoG and inter coded neighbouring CU with confidence factor set to 1 for its bins of HoG. In another embodiment, the statistics of bin values of the HoG is used as the confidence factor. For example, higher confidence factor can be set to the HoG where bin values are with a small standard deviation.

After building the HoG for the current CU, the remaining steps of DIMD procedure can be applied for identifying intra modes with high accumulated gradient values for prediction blending operation. CU with this inherited HoGs is considered as a sub-mode DIMD and an extra flag as an explicit syntax element is used for specifying the usage of this sub-mode if the extra flag is set to true. In another embodiment, if the number of available neighbouring HoG is larger than a threshold T1 and/or the percentage of the neighbouring CU with available HoG is larger than a threshold T2, this DIMD sub-mode is inferred to be used directly without extra signalling.

3. Neighbouring HoG from CU Encoded by DIMD with or without Sub-Mode (Inherited HoG):

With the added sub-mode of DIMD by inheriting the HoG from neighbouring CUs. The condition C.1 from the previous section can be extended. For one embodiment, the valid neighbouring HoG comes from the CU coded with DIMD with sub-mode (inherited HoG) and CU coded without sub-mode (i.e., the original DIMD coding flow) turned on.

4. HoG Inheritance with Selected Regions

Inheritance of the HoG can be applied from all the allowable regions or only from selected regions. The possible combinations of the regions are:
R.1 From above and left regions
R.2 From above, above-left, left and bottom-left regions
R.3 From above region only
R.4 From left region only

For one embodiment, HoG inheritance from R.2, R.3, and R.4 are used jointly to derive three group of intra modes. An explicit syntax as an index (e.g. 0: R.2, 1: R.3, 2: R.4) to select the final region used (normally through RDO process). For another embodiment, a validation process is first applied to the region. A threshold Tr0 for the following attribute Dratio is checked for some regions to become valid. Dratio can be determined based on N and D, where N is number of samples for one side (e.g. above side or left side) and D is the number of samples associated with a CU with valid HoG stored in the HoG buffer.

$$Dratio = D / N .$$

If Dratio >=Tr0, the side is valid, and R.3 and R.4 can be viewed as valid for HoG inheritance. R.2 is regarded as always valid. When some of the region is invalid, the index can change its meaning. For example, if only R.2 and R.4 are valid, index 0 is for R.2 and index 1 is for R.4. If R.3 and R.4 are all invalid, then no need to signal the index and only R.2 is used for the HoG inheritance.

In another embodiment, a threshold Tr1 is used for R.2 for the validity check. Tr0 and Tr1 can be set to the same value or different values. If Tr0 and Tr1 are always the same, only one threshold is needed. After validity check, there may be partial regions available, such as R.3 and R.4 and the index meaning of the signalled index is changed accordingly. In one extreme case, all the regions are invalid. For this situation, the CU cannot be encoded with DIMD mode with inherited HoGs. In another embodiment, TM (Template Matching) costs or boundary matching costs are calculated with the intra modes derived from different regions. Then final intra mode are selected with the lowest cost and no extra syntax element is signalled.

### 5. Position-Dependent Weighting for Combining Predictions

In addition to selecting a specific region for adopting its derived intra modes for prediction, it is possible to keep all the intra mode candidates from multiple regions and generate blended predictions from all the intra modes. For example, intra modes from R.2, R.3 and R.4 are used to generate their predictions. Because single prediction is required to encode the CU, predictions from R.2, R.3 and R.4 can be blended to form the final prediction. We derive a confidence level for all the size and for the L-shape as follows:

$$Conference level for L - shape = Number of above and left reconstructed pixels coded with DIMD / ( width + height ) \qquad CF \text{.1}$$

$$Conference level for above side = Number of above reconstructed pixels coded with DIMD / width \qquad CF \text{.2}$$

$$Conference level for left side = Number of left reconstructed pixels coded with DIMD / height \qquad CF \text{.3}$$

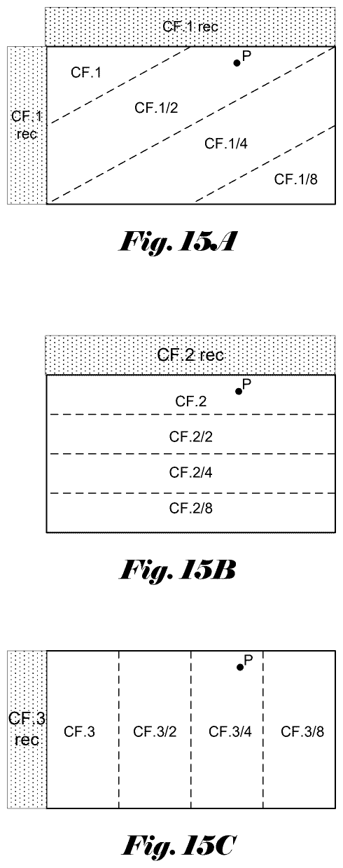

These confidence level can be further modified according to the sample position of the CU when prediction blending is conducted. FIGS. 15A-C shows examples of position-dependent weights derived from the confidence level. As shown in FIGS. 15A-C, the sample positions are divided into 4 bands and each band uses a specific weight. When both left and above regions are used (FIG. 15A), the bands are formed using diagonal partition lines. When only the above region (FIG. 15B) is used, the 4 bands are formed by using horizontal partitioning lines. When only the left region (FIG. 15C) is used, the 4 bands are formed by using vertical partitioning lines. Furthermore, weights shown in FIGS. 15A-C have larger values for bands closer to the neighbouring region(s). While the weight ratios correspond to 1, ½, ¼, and ⅛ in this example, other weight rations can also be used.

The blended value of sample P in FIG. 15 can be calculated by the following formula:

$$P = ( P 0 * CF \cdot 1 / 2 + P 1 * CF \cdot 2 + P 2 * CF \cdot 3 / 4 ) / ( CF \cdot 1 / 2 + CF \cdot 2 + CF \cdot 3 / 4 ) .$$

6. HoG Blending with Current CU's HoG

In pure DIMD inheritance mode, only neighbouring HoGs are used for generating the HoG for the current CU. In the proposed method in this section, we further adopt the HoG of the current CU for coding. HoG for the current CU is built with the original DIMD procedure. Then mixing the HoGs from neighbours and the HoG of current CU with certain weights to build the final mixed HoG. In another embodiment, the neighbours which derive the neighbouring HoGs, are only from the selected regions specified in the section “HoG Inheritance with Selected Regions.” Methods for deciding the weights can be as follows:
M.1 Equal weights for each HoG
M.2 Weights related to statistics of CU, where the HoG is derived (for example: standard deviation of the bin values)
M.3 Like M.1, equal weights for each neighbouring HoG with an additional weight for the HoG of current CU
M.4 Like M.2, weights related to statistics of CU where the HoG is derived. An additional weight for the HoG of current CU.
M.5 Weights related to the distance between the neighbouring CU (where the neighbouring HoG is derived) and the current CU. For example, if one neighbouring HoG is derived by the first neighbouring CU far away from the current CU, the weight for the one will be smaller than the weight for another neighbouring HoG which is derived by the second neighbouring CU near the current CU.

In one embodiment of M.5, the distance between two CUs can be the distance between the centre positions of the two CUs. In another embodiment, the distance between two CUs can be the shortest distance between the 4 possible choices of the corners of the first CU and the 4 possible choices of the corners of the second CU. The distance is normally calculated by the following formula:

$$Distance between two CUs = square root of ( {( {X}_{0} - {X}_{1} )}^{2} + {( {Y}_{1} - {Y}_{2} )}^{2} ) .$$

In another embodiment, the distance can be the difference between one of the coordinates with smaller difference. For example, the distance is the smaller one from absolute value of (X₀−X₁) and absolute value of (Y₀−Y₁).

The sum of the weights for M.1 to M.5, or the sum of the weights for any subset of M1 to M5 is used as the denominator for normalizing the mixed amplitudes of the bins of the HoG. The normalization process is required for keeping the numerical range of the amplitudes of the HoG. After the mixed HoG is built, the remaining procedure of the DIMD is conducted.

### 7. Adoption of Temporal Regions' HoGs

In FIG. 14, HoG of regions R, B, and BR can also be available when coding in a non-I slice by referring to reference frames. In addition to acquiring the HoG from regions A, AL, L, and BL, the collocated areas of reference frames in list 0 or list 1 can have CU coded with DIMD mode (with or without inherited HoG). For example, CU_R0, CU_B0, CU_B1, CU_B2, and CU_BRC can have their associated HoGs stored in the HoG buffer. Therefore, these HoG can be utilized with the same procedure mentioned in previous sections. For instance, HoG validation, HoG weight assignment and HoG mixing can be done with these HoGs from reference frames. For each reference frame to have their own HoG buffer, extra storage is required, and the amount of storage is proportional to the maximal number of reference frames. In another embodiment, if CU used to build the neighbouring HoG is from reference frames, an extra weight assigned to the blending the HoG is adopted. In another embodiment, if the CU used to build the neighbouring HoG is from reference frames, an extra weight derived from the POC distance for the blending the HoG is utilized.

### 8. HoG Propagation for DIMD Intra Coding in Non-I Slice

For an I slice, the DIMD process is conducted, and HoGs of the CUs are stored in the HoG buffer. Normally only the CU coded with DIMD can have its non-inherited HoG or inherited HoG stored to be used for the inter coding slice as the HoG inheritance source described in the previous section. We further propose a HoG propagation mode. When coding the CU not coded with intra modes in an inter slice, the HoG can be retrieved from the HoG buffer through motion vector (MV) or block vector (BV) for updating the HoG buffer with the retrieved HoG. With the HoG inferred by MV or BV, HoG is propagated through the guiding information. The propagation process can be done through several non-I slice frames and keep filling the HoG buffer with MV or BV guided HoG update. Therefore, it is easier for a CU in non-I slice to find valid neighbouring HoGs for pure DIMD inheritance mode or DIMD HoG blending mode. Compared to the previous section with the HoG coming from reference frames, the HoG storage requirement for propagation mode is constrained. For one implementation, single HoG buffer can be utilized. The MV or BV is utilized to refer the HoG and read the HoG, then write to the HoG buffer portion of the current CU. Therefore, after coding of the current CU, the HoG buffer for propagation has been updated with latest HoG context.

9. Multiple Filters with Implicit Selection of Pre-Filters and Gradient Extraction Filter Pairs

HoG for DIMD coding mode is derived by using a pair of Sobel filters to generate the gradients. The Sobel filters are applied to the reconstruction samples in the L-shape neighbouring region with thickness of 3 pixels. For boosting the coding gain, we proposed a two-stage filtering scheme to derive intra modes for coding. First stage is a pre-filtering stage of the reconstruction samples, filters like the bi-lateral filter or Gaussian filter are used to filter the reconstruction samples. In the second stage, there are multiple pairs of filters to derive the gradients (including amplitude and phase) of the neighbourhood. Assume P pre-filters are utilized, and Q pairs of filters are used for gradient calculation. Multiple intra modes (or multiple groups of intra modes) from these filters are available, the total combinations are P*Q. TM costs (or other kinds of cost evaluation, such as boundary matching) are calculated for sorting the P*Q combinations. The following strategies can be used to decide the final intra mode (or group of intra modes) derived from these P*Q combinations.
S.1 keep the one with lowest cost, no signalling
S.2 keep K combinations with lowest costs, signalling an index (0~K−1)
   10. HoG Reuse from Non-DIMD or Non-DIMD-Inheritance CUs

For a CU encoded with DIMD or DIMD inheritance mode, HoG is stored to be utilized for other CUs in DIMD inheritance mode. Meanwhile, as mentioned in Section 1, for condition C.5 where HoG is always stored for every CU. However, some coding modes do not generate the HoG. Always storing the HoG requires extra computation to be done. For encoder, the problem can be alleviated because RDO process tries various coding modes, and the HoG can be saved and reused for the mode that does not generate HoG. But for decoder side, the HoG should be generated when decoding a CU that requires a neighbouring CU's HoG. One solution is to generate the HoG for every CU if the HoG is not available after reconstructing that CU. However, this may cause a large increase in the decoding time spent on building HoG and most of the HoG may not be utilised in DIMD inheritance mode. For example, intra coding mode MIP (Matrix-based Intra Prediction) in earlier ECM versions does not require HoG to complete its coding process. Recently, an extended method is proposed for MIP to select between MTS (Multiple Transform Selection) and LFNST (Low-Frequency Non-separable Secondary Transform) modes based on DIMD derived intra angle. Therefore, HoG is available for MIP with this extension. In Section 1 the conditions C.2 to C.5 are all with HoG computed even if the CU is not coded with DIMD or DIMD inheritance mode. For storing more HoG for inheritance and without introducing extra burden (unlike the strategy of always storing the HoG) in decoder side, we propose to reuse HoG generated for other non-angular coded intra CU, including MIP, intraTMP, SGPM (Spatial Geometric Partitioning Mode) with MTS and LFNST selected by DIMD. In addition, HoG from TIMD, IBC-GPM (Geometric Partitioning Mode), CIIP, IBC-CIIP where intra MPM is derived is also utilized. DIMD process is conducted for these modes with HoG generated in the intermediate coding step. Storing the HoGs generated by these modes does not put extra burden on the decoder because the HoGs are required when decoding those CUs. These HoGs can be inherited by other CUs when coded with DIMD inheritance mode.

### 11. HoG Generated for Inter-Coded CUs for DIMD Inheritance

In order to increase the chance for DIMD inheritance mode to be applied in intra CUs within inter slice. CU coded with inter coding mode can generate a representative HoG stored for DIMD inheritance. For one embodiment, inter coded CU builds its HoG upon a predefined area of the CU. This area can be the L-shape template outside and adjacent to the CU. In another embodiment, this area can be the whole CU or partial area of the CU. In another embodiment, this area can be a joint area with the L-shape template and part or all of the CU area. This predefined area can be assigned with a nearly constant ratio compared to the CU area. Otherwise, this predefined area can be adjusted according to the CU size. For example, larger CU with smaller thickness of the template or smaller area of the internal part of the CU can be used to reduce the total computation while still preserving the coding gain.

In another embodiment, HoG of the inter CU is first generated. However, if the HoG can satisfy certain check conditions, the HoG is stored for DIMD inheritance, otherwise the HoG is discarded. The check condition can be the statistics of the HOG, such as the standard deviation of the histogram entry values or there should be multiple histogram entries larger than a threshold.

In another embodiment, HoG of the inter CU is generated only if there is a nearby intra coded block in the neighbourhood. The area of the neighbourhood can be a predefined fixed area or a dynamic area according to the size of the inter CU itself.

In another embodiment, to further reduce the computation burden for generating the HoG, inter CU with more residue is selected as the candidate for HoG generation and stored for DIMD inheritance. The amount of residue can be estimated by the transform coefficients of the CU. Both the number of the non-zero coefficients and/or sum of the absolute or square coefficient values and/or other statistics of the coefficients can be used to judge whether a CU is coded with enough residue.

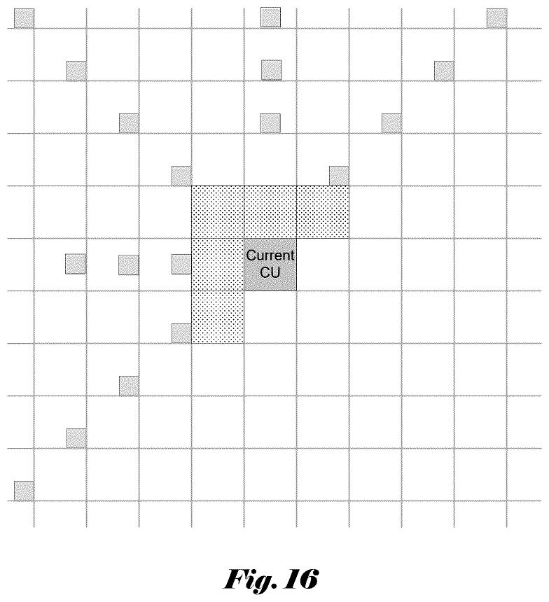

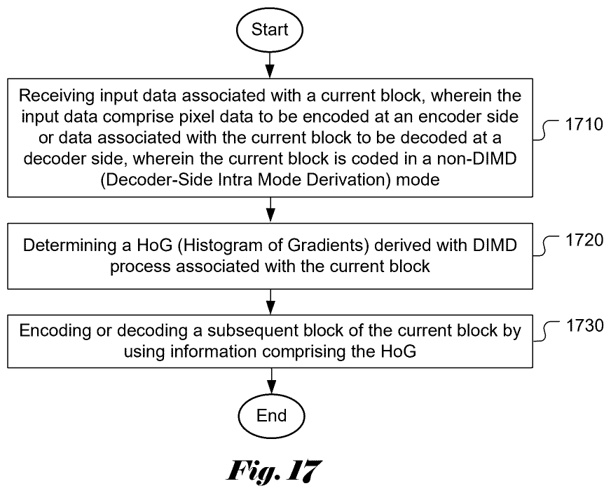

In another embodiment, the HoG of the inter CU is generated when needed. As shown in FIG. 16, if the current CU is coded with DIMD inheritance mode, the neighbouring area (filled with dots) is searched to find if there is any CU with HoG available. If there is an intra-coded CU, this CU may already have HoG stored. Otherwise, if the CU is inter-coded, statistics of the CU can be checked and if a certain condition meets, a representative HoG is generated to be inherited. The condition can correspond to whether there is any nearby intra-coded CU and/or whether the number of non-zero transform coefficients and/or sum of the absolute or square coefficient values satisfy certain threshold. Therefore, the representative HoG of the inter CU is generated when it is needed. In another embodiment, the HoG search process is extended to non-adjacent locations as the grey-square locations shown in FIG. 16. The representative HoG of the inter CU for those locations is generated when it is needed (when satisfying certain conditions). With this on-demand generation of HoG for inter CU, computation burden of generating the HoG can be further reduced.

Any of the foregoing proposed methods can be applied to both DIMD luma and DIMD chroma derivation process.

Any of the foregoing proposed methods of derivation, storage and reuse of HoG associated with non-DIMD coded blocks can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

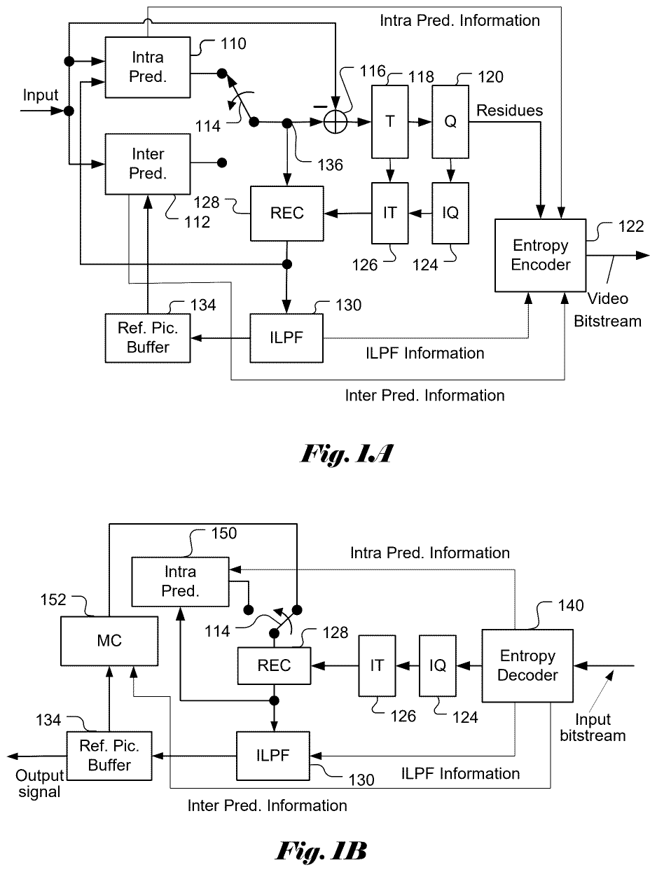

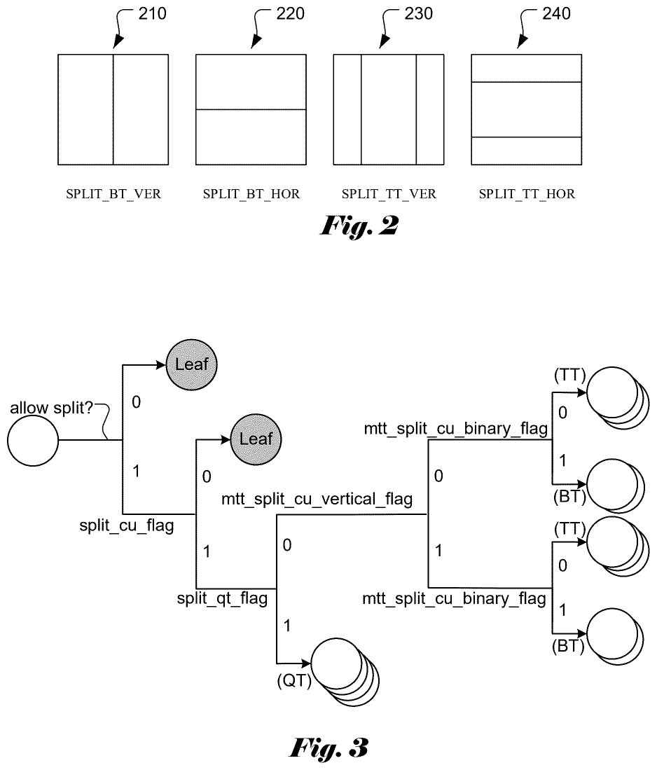

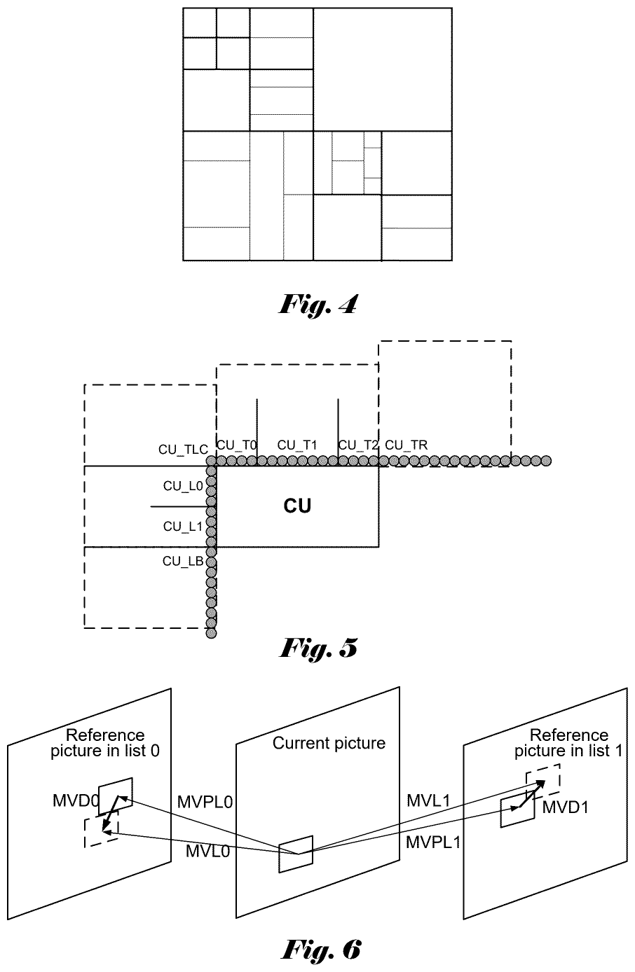

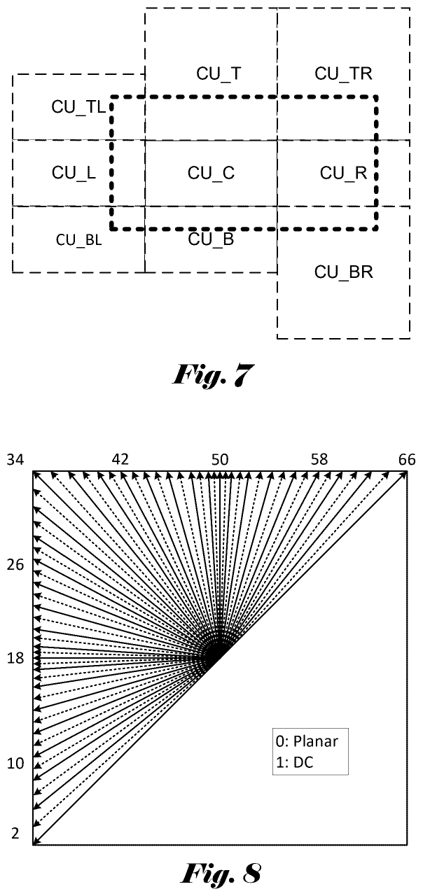

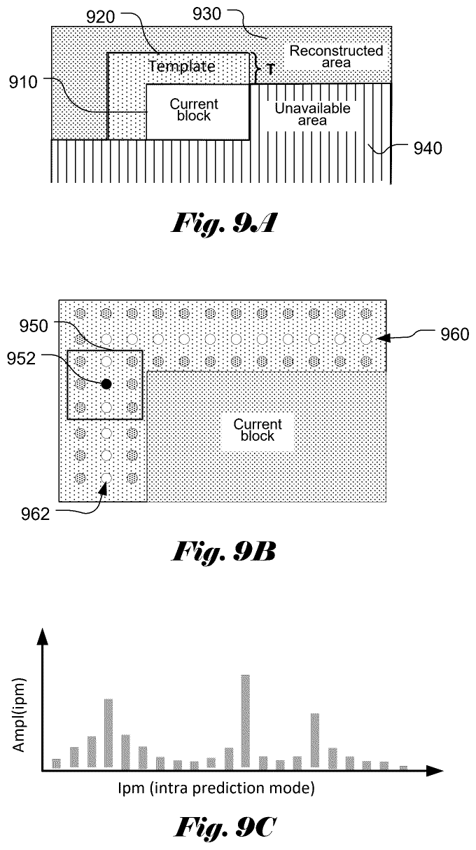

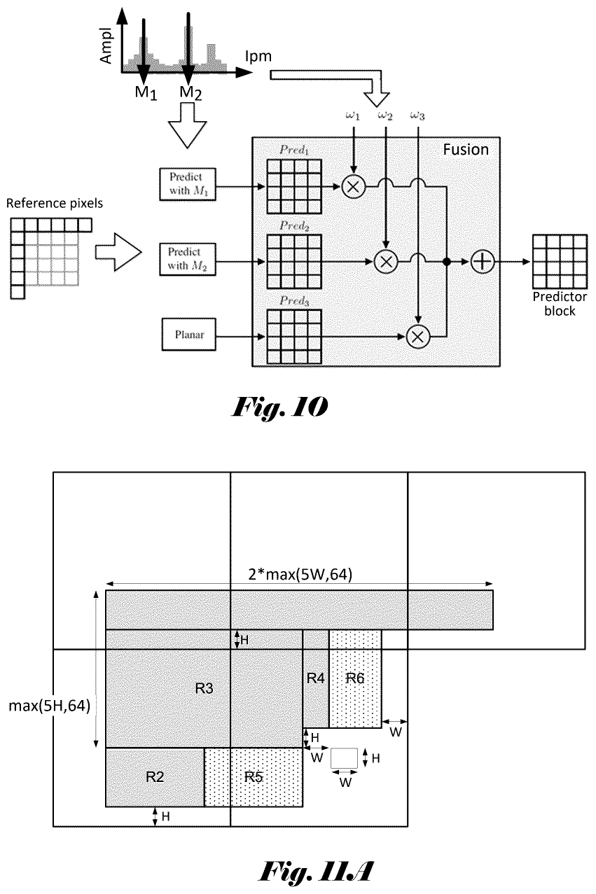

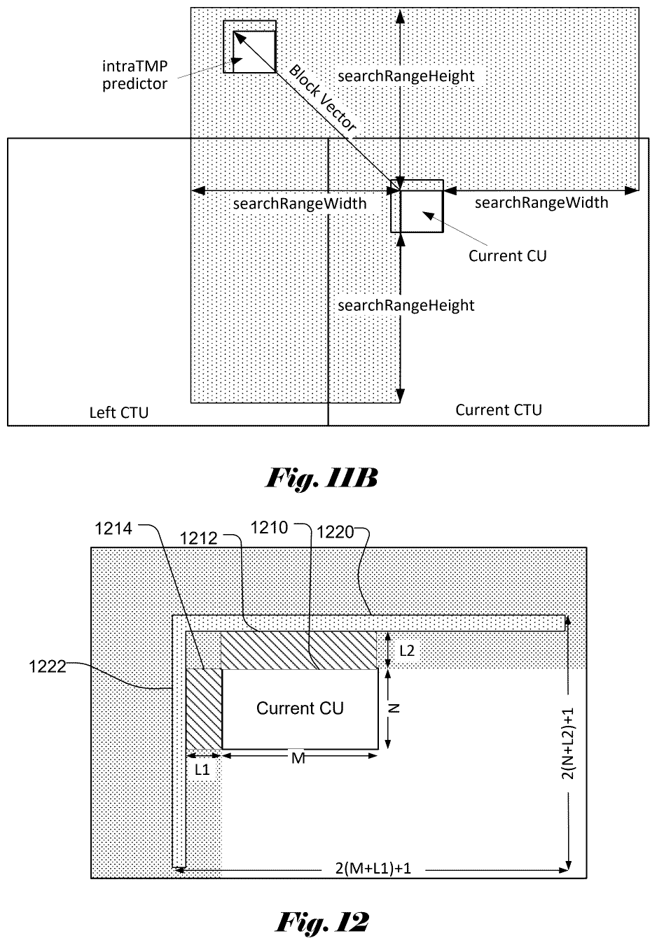

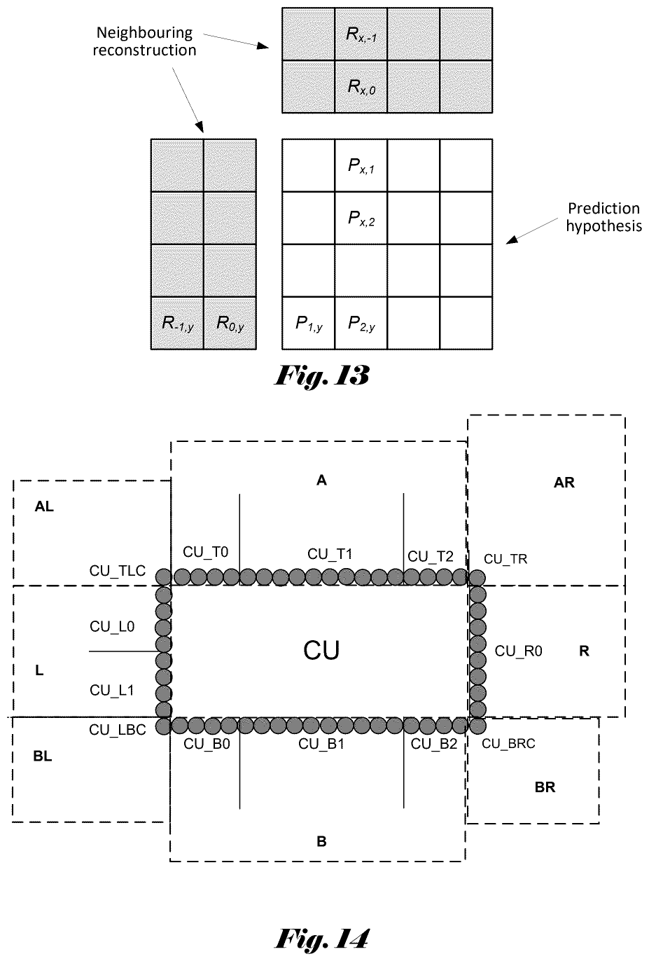

The HoG derivation, storage, and reuse methods as described above can be implemented in an encoder side or a decoder side. For example, any of the proposed candidate derivation method can be implemented in an Intra coding module (e.g. Intra Pred. 150 in FIG. 1B) in a decoder or an Intra coding module is an encoder (e.g. Intra Pred. 110 in FIG. 1A). Any of the proposed method of HoG storage, inheritance and blending can also be implemented as a circuit coupled to the intra coding module at the decoder or the encoder. However, the decoder or encoder may also use additional processing unit to implement the required cross-component prediction processing. While the Intra Pred. units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 17 illustrates a flowchart of an exemplary video coding system that stores and reuses the HoG of non-DIMD coded blocks according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block is received in step 1710, wherein the input data comprise pixel data to be encoded at an encoder side or data associated with the current block to be decoded at a decoder side, wherein the current block is coded in a non-DIMD (Decoder-Side Intra Mode Derivation) mode. A HoG (Histogram of Gradients) derived with DIMD process associated with the current block is determined in step 1720. A subsequent block of the current block is encoded or decoded by using information comprising the HoG in step 1730.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or data associated with the current block to be decoded at a decoder side, wherein the current block is coded in a non-DIMD (Decoder-Side Intra Mode Derivation) mode;
determining a target HoG (Histogram of Gradients) derived with DIMD process associated with the current block; and
encoding or decoding a subsequent block of the current block by using information comprising the target HoG.

2. The method of claim 1, where the target HoG is stored in a buffer.

3. The method of claim 1, wherein the target HoG is generated for one or more non-angular coded intra modes.

4. The method of claim 3, wherein said one or more non-angular coded intra modes comprise MIP (Matrix-based Intra Prediction), intraTMP (Intra Template Matching Prediction), SGPM (Spatial Geometric Partitioning Mode) with MTS (Multiple Transform Selection) and LFNST (Low-Frequency Non-separable Secondary Transform) selected by DIMD.

5. The method of claim 1, wherein the target HoG is generated during intra MPM (Most Probable Modes) derivation for TIMD (Template-Based Intra Mode Derivation), IBC (Intra Block Copy)-GPM (Geometric Partitioning Mode), CIIP (Combined Inter and Intra Prediction), or IBC-CIIP.

6. The method of claim 1, wherein the target HoG corresponds to a representative HoG generated for the current block coded in an inter mode.

7. The method of claim 6, wherein the representative HoG is generated based on a predefined area of the current block.

8. The method of claim 7, wherein the predefined area of the current block corresponds to an L-shape template outside and adjacent to the current block, part or all of the current block, or a combination thereof.

9. The method of claim 6, wherein the representative HoG is stored only if one or more conditions are satisfied.

10. The method of claim 9, wherein said one or more conditions comprise checking statistics of the representative HOG.

11. The method of claim 10, wherein the statistics of the representative HOG comprise standard deviation of histogram entry values.

12. The method of claim 9, wherein said one or more conditions comprise checking nearby blocks coded with an intra mode.

13. The method of claim 9, wherein said one or more conditions comprise checking amount of coding residues.

14. The method of claim 9, wherein said one or more conditions comprise checking non-adjacent blocks coded with an intra mode.

15. The method of claim 1, wherein said determining the target HoG derived with the DIMD process comprises determining a first HoG by inheriting multiple HoGs from adjacent and/or non-adjacent neighbourhood through averaging bins of the multiple HoGs.

16. The method of claim 15, wherein said determining the target HoG derived with the DIMD process further comprises deriving a second HoG of the current block using the DIMD process, and generating a final HoG as the target HoG by blending the first HoG and the second HoG.

17. The method of claim 16, wherein the final HoG is used to decide intra modes for prediction blending.

18. The method of claim 1, wherein an extra flag is used for specifying whether the current block uses one or more inherited HoGs from neighbouring HoGs.

19. The method of claim 1, wherein whether the current block uses one or more inherited HoGs from neighbouring HoGs is determined implicitly according to whether a number of neighbouring HoGs is larger than a first threshold and/or a percentage of neighbouring blocks with an available HoG is larger than a second threshold.

20. An apparatus for video coding, the apparatus comprising one or more electronics or processors arranged to:
receive input data associated with a current block, wherein the input data comprise pixel data to be encoded at an encoder side or data associated with the current block to be decoded at a decoder side, wherein the current block is coded in a non-DIMD (Decoder-Side Intra Mode Derivation) mode;
determine a target HoG (Histogram of Gradients) derived with DIMD process associated with the current block; and
encode or decode a subsequent block of the current block by using information comprising the target HoG.
